(19) United States
(12) Patent Application Publication
(10) Pub. No.: US 2016/0023116 A1
(43) Pub. Date: Jan. 28, 2016

(54) Electronically mediated reaction game

(71) Applicant: SPITFIRE TECHNOLOGIES, LLC, Dayton, OH (US)

(72) Inventors: Christopher S. Wire, Centerville, OH (US); Matthew J. Farrell, Springboro, OH (US); Brian T. Faust, Springboro, OH (US); John P. Nauseef, Kettering, OH (US); Dustin L. Clinard, Dayton, OH (US); Patrick M. Murray, Dayton, OH (US); John C. Nesbitt, Tipp City, OH (US)

(21) Appl. No.: 14/790,913

(22) Filed: Jul. 2, 2015

Related U.S. Application Data
(60) Provisional application No. 62/020,711, filed on Jul. 3, 2014.

(51) Int. Cl. A63F 13/58; A63F 13/213; A63F 13/53; A63F 13/54; A63F 13/31; A63F 13/79

(52) U.S. Cl. CPC A63F 13/58; A63F 13/31; A63F 13/79; A63F 13/53; A63F 13/54; A63F 13/213

(57) ABSTRACT

Mobile devices or other client devices generally support applications that provide content to users. Emotional analytics entails making inferences about a user's emotions based on sensor data such as a video stream of the user. When combined with a videoconferencing application or other digital media, emotional analytics may be employed to make games that respond to user emotions. Video streams from a game may also be analyzed in real time to ensure that the game's rules are obeyed. Disclosed are techniques for administering and managing a digital media-based game using emotional analytics and object recognition.

### RELATED APPLICATIONS

The present application relates and claims priority to U.S. Provisional Patent Application No. 62/020,711, entitled “Electronically mediated reaction game,” filed Jul. 3, 2014, which is hereby incorporated by reference in its entirety.

### BACKGROUND

1. Field of the Disclosure

The present application generally relates to communications technology and, more specifically, to systems and methods for enabling gameplay using videoconferencing or other digital media technology while promoting user safety and security.

2. Description of Related Art

People enjoy games or contests of will such as the staring game, in which two players stare at each other until one of them loses by blinking. However, the determination of a winner is often subject to debate. Furthermore, to play such games or contests, the competitors generally have to be physically proximate to one another, limiting both the opportunity to play and the number of opponents available.

With the proliferation of mobile devices in the consumer marketplace and the increasingly robust cellular and telecommunications infrastructure, mobile application developers have more flexibility when developing new applications.

### SUMMARY

In accordance with the disclosed principles, one or more users may participate in a digital media-based reaction game involving computer recognition of the users' emotions. The game may entail pairs or groups of participating users facing off against each other and attempting to make one another trigger a loss criterion, such as making a facial expression (e.g., smiling) or exhibiting movement beyond a configurable or fixed threshold. Alternatively, individual users may play by themselves (e.g., using a timer and/or against a computer opponent). Each user may have a personal electronic device having one or more sensing elements integrated into or in communication with the users' devices, where the sensing elements may gather and provide sensor data to a decision engine that is also integrated into or in communication with the users' devices. The decision engine may send the sensor data to an emotion detection engine or may analyze the sensor data directly to determine the emotional states of the users or participants of the games. These emotional states of the participants may be continuously, periodically, or intermittently tested against the loss criteria to determine if any loss criterion is satisfied. When all but one of the participants have triggered the loss criteria, the decision engine may indicate to the user devices that a game session is complete and the remaining participant (e.g., who had not triggered the loss criteria) may be recorded and presented as the winner.

A communications server may be used to enable the communication and gameplay between the participants. During a game session, the participants may receive video streams or image frames of one another as well as corresponding audio streams through the communications server. The participants may further be permitted to select one or more features (e.g., visual overlays or audio clips) to be presented to the other users through their devices to provoke a response such that their opponents trigger a loss criterion.

An account management server may store information associated with the participants. The stored information may include a list of games previously played, friends, in-game currency (e.g., tokens), and other information.

A user behavioral safeguard subsystem may also receive and analyze the user content (e.g., video content and audio content) provided by the participating users' devices to detect objectionable content or behavior in real time (e.g., by scanning video content for objects previously flagged as objectionable). When objectionable content is detected, the user behavioral safeguard subsystem may initiate a safety protocol. The safety protocol may prevent users from seeing, hearing, or otherwise being exposed to the objectionable content provided by other users. In some embodiments, the safety protocol may include blanking or disabling a video feed, muting an audio feed, and/or disconnecting the players from one another and ending a game session. If the game session is not ended, the user behavioral safeguard subsystem may permit re-enablement of communications (e.g., video feeds) between the participants. The account management server may store a record of user infractions (e.g., the number or frequency by which a user provides objectionable content or otherwise fails to follow the rules of a game). A poor record may result in one's account being temporarily or permanently suspended from playing the reaction game.

The user behavioral safeguard subsystem may comprise or be in communication with a flagged object database that stores objects that are flagged by users, system administrators, or automatically. The flagged object may be stored with identification information used to identify the flagged objects in a content stream. When the user behavioral safeguard subsystem receives data, it may check the received data against the flagged object database. Upon determining that flagged object exists in the received data, the user behavioral safeguard subsystem may report the detection, such that responsive action may be taken (e.g., a safety protocol). In some embodiments, the user behavioral safeguard subsystem may also analyze received data to ensure that the participants' faces and/or other objects are present, if such objects are required by the game's rules.

### BRIEF DESCRIPTION OF DRAWINGS

Features, aspects, and embodiments of the disclosure are described in conjunction with the attached drawings, in which:

FIG. 1A shows a schematic diagram illustrating a system for implementing and mediating a reaction game;

FIG. 1B shows a schematic diagram illustrating communications between multiple devices that may participate in a reaction game;

FIG. 2 shows a schematic diagram illustrating a presentation of an introductory game screen associated with a mediated reaction game on a personal electronic device;

FIG. 3 shows a schematic diagram illustrating a presentation of game history associated with a mediated reaction game on a personal electronic device;

FIG. 4 shows a schematic diagram illustrating a presentation of a leaderboard associated with a mediated reaction game on a personal electronic device;

FIG. 5 shows a schematic diagram illustrating a presentation of a friends list associated with a mediated reaction game on a personal electronic device;

FIG. 6 shows a schematic diagram illustrating a presentation on a personal electronic device during a session of a mediated reaction game;

FIG. 7 shows a schematic diagram illustrating a presentation that may occur on a personal electronic device after a safety protocol has been implemented;

FIG. 8 shows a flowchart illustrating an exemplary process for participating in a mediated reaction game;

FIG. 9 shows a flowchart illustrating an exemplary process for conducting a mediated reaction game; and

FIG. 10 shows a flowchart illustrating an exemplary process for providing user safety in a mediated reaction game.

These exemplary figures and embodiments are to provide a written, detailed description of the subject matter set forth by any claims in the present application. These exemplary figures and embodiments should not be used to limit the scope of any such claims.

Further, although common reference numerals may be used to refer to similar structures for convenience, each of the various example embodiments may be considered to be distinct variations. When common numerals are used, a description of the corresponding elements may not be repeated, as the functionality of these elements may be the same or similar between embodiments. In addition, the figures are not to scale unless explicitly indicated otherwise.

### DETAILED DESCRIPTION

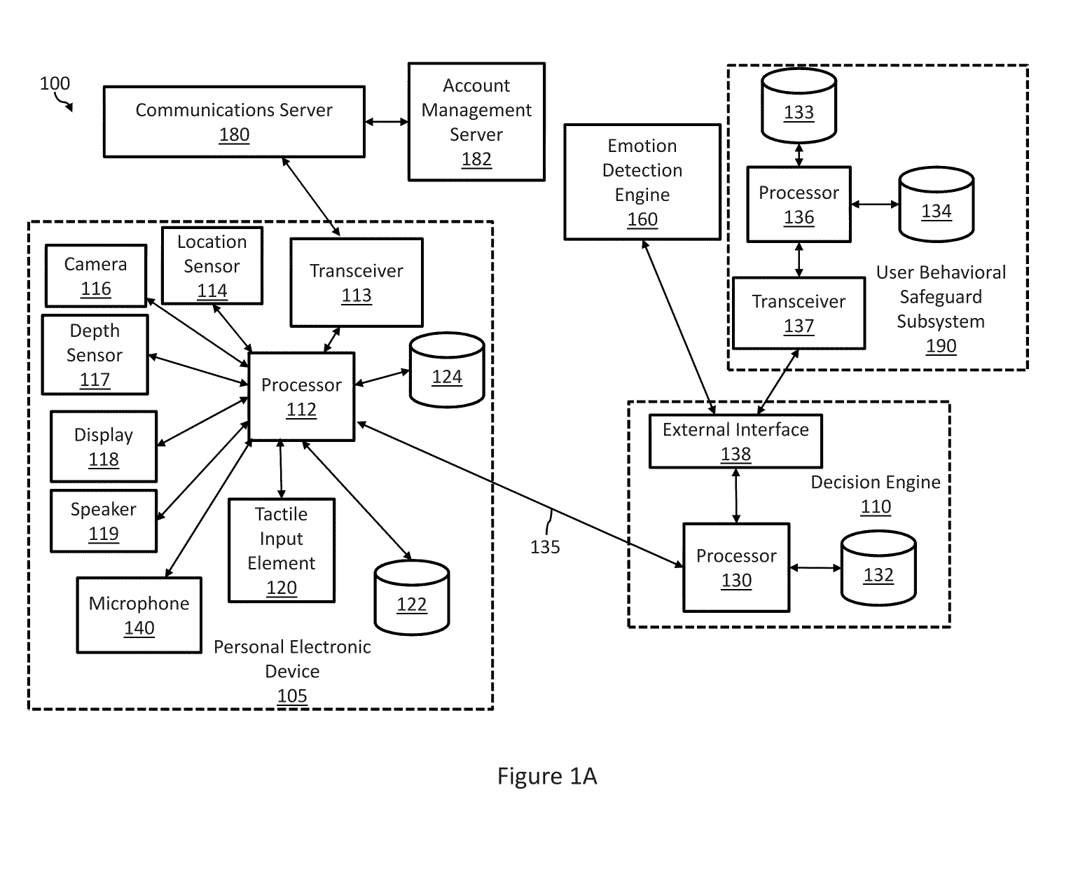

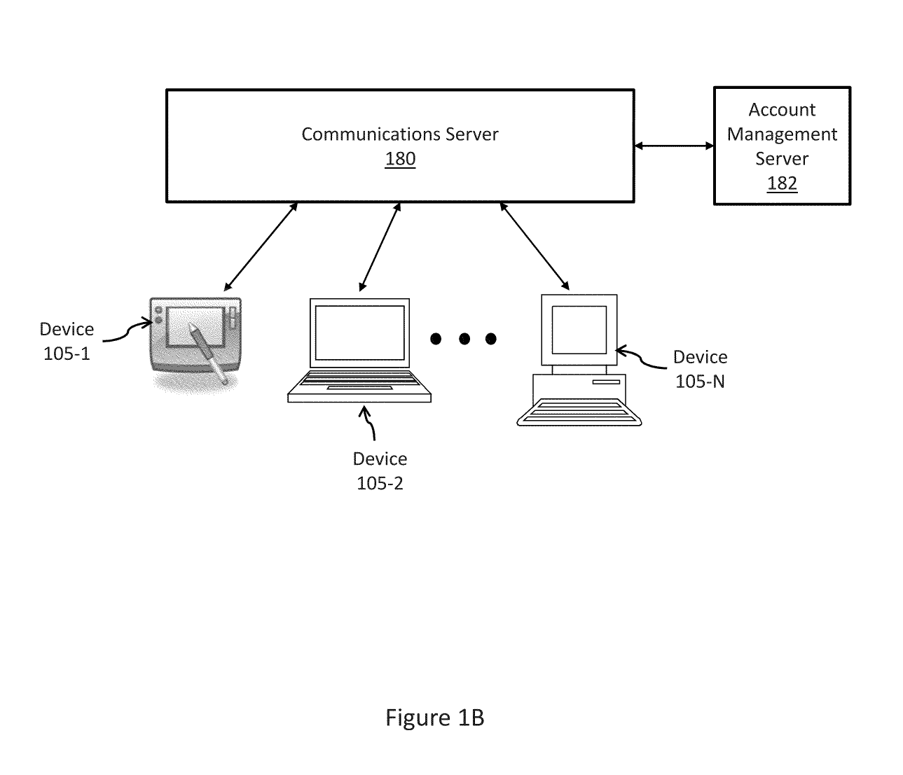

FIG. 1A shows a schematic diagram illustrating a system 100 for implementing and mediating a reaction game. One or more users playing the reaction game may each have a personal electronic device 105, which may be a smart phone, tablet, laptop computer, desktop computer, or another type of device that may enable the user to communicate with other users. In some embodiments, the device 105 may be a gaming console equipped with a camera and/or microphone, such as a PlayStation, Xbox, Wii, a later generation or derivative thereof, or another gaming console.

The personal electronic device 105 may have a transceiver 113 to communicate with a communications server 180 that facilitates sessions of the reaction game. The personal electronic device 105 may further comprise a plurality of sensing elements that may enable the device 105 to collect sensor data potentially indicative of emotional information, surrounding objects, or other contextual information. In the embodiment shown in FIG. 1A, the device 105 may have a location sensor 114, a camera 116, a depth sensor 117, a tactile input element 120, and a microphone 140. The device may further comprise a processor 112 that may receive the sensor data and, in some embodiments, have the sensor data transferred to entities external to the device 105, as will be described further below. Some sensor data such as a video stream from the camera 116 and an audio stream from the microphone 140 may be sent to the communications server 180 through the transceiver 113 and received by one or more users of other devices 105 (e.g., during a game session). The processor 112 may operate based on instructions stored on a memory device 122.

While particular sensing elements are shown in the device 105 of FIG. 1A, it is to be understood that more, fewer, or different sensing elements may be implemented to enable determination of emotional information or other contextual information (e.g., to facilitate the response game). For example, information from the location sensor 114 may be used to match players from the same country or other type of geographic region with one another. In some embodiments, one or more of the sensing elements may be implemented externally to the device 105.

The device 105 may further comprise output elements such as a display 118 and a speaker 119 for providing information and feedback to the user of the device 105 during the reaction game. The display 118 and/or the speaker 119 may additionally or alternatively be externally connected to the device 105. In some embodiments, the display 118 may be closely integrated with the tactile input element 120, which may be implemented as a touch screen sensor array. In other embodiments, the tactile input element 120 may be a discrete input element such as a keyboard and/or a mouse (e.g., when the device 105 is a desktop computer).

The device 105 may communicate over a connection 135 with a decision engine 110 that may receive the sensor data to determine or enable determination that a user has lost the reaction game or that a flagged object is present. In some embodiments, the decision engine 110 may be provided by a backend server, and the connection 135 may be implemented over the internet. When located on a backend server, the decision engine 110 may service many devices 105 in parallel. Further, the decision engine 110 may service multiple devices 105 in a common game session, thereby centralizing and avoiding duplication of the processing required to determine winners and/or flagged objects. In general, sensor data may be sent from one or more devices 105 to the decision engine 110 over the connection 135, and the decision engine 110 may provide outcome determinations, screen blackout instructions, and other control information back to the one or more devices 105.

In other embodiments, the connection 135 may be a direct wired or wireless connection, and the decision engine 110 may be collocated with the device 105. In yet other embodiments, the decision engine 110 may be fully integrated into the device 105, which may reduce the amount of data transmitted from the device 105 and may reduce the latency associated with providing outcome determinations and/or blackout instructions.

The decision engine 110 may comprise a processor 130 operating on instructions provided by a memory device 132. The processor 130 may enable the decision engine 110 to analyze, collect, and/or synthesize sensor data from the device 105 to determine when a user wins the game or when the sensor data includes flagged objects.

The decision engine 110 may offload some of its processing to other specialized entities to help make these determinations. For example, the decision engine 110 may have an external interface 138 that enables the decision engine 110 to communicate with external hardware or services, such as an emotion detection engine 160. The emotion detection engine 160 may analyze video streams from the camera 116 and/or audio streams from the microphone 140 on one or more game participants' user devices 105 to provide feedback about perceived emotions of the participants. These emotions may include happiness, excitement, boredom, fear, anger, and discomfort. Video streams may comprise image frames having computer-recognizable facial expressions corresponding to such emotions. Audio data may also be used to detect pitch or changes in pitch that may corroborate or supplement the emotional information derived from the video data. Detected ambient noise may be used to provide further contextual clues.

The emotion detection engine 160 may also provide a degree of confidence in the emotion information (e.g., determination that a user is feeling a known emotion) that it provides to the decision engine 110 and/or the perceived extent to which the user feels a certain emotion. This additionally information allows the decision engine 110 to better determine when a game participant satisfies any of the loss criteria. In some embodiments, the emotion detection engine 160 may be fully integrated into the decision engine 110, such that the external interface 138 is not required, at least for detecting emotions. In some embodiments, the external interface 138 may be an application programming interface (API) that enables the decision engine 110 to exchange information with the emotion detection engine 160.

The decision engine 110 may alternatively or additionally use the external interface 138 to communicate with a user behavioral safeguard subsystem 190, which may analyze the sensor data to determine user violations (e.g., failures to follow the predefined rules and/or code of conduct of a game). The user behavioral safeguard subsystem 190 may comprise a processor 136, a transceiver 137, a memory device 133, and a flagged object database 134. The transceiver 137 may receive sensor data such as video and/or audio streams associated with an ongoing reaction game. The processor 136 may, based on instructions stored on the memory device 133, search the received sensor data to determine whether or not users are following rules associated with the game. If a rule is violated, the user behavioral safeguard subsystem 190 may initiate a safety protocol, as will be described further below.

To assist with monitoring and violation detection, the user behavioral safeguard subsystem 190 may use the flagged object database 134, which may store digital signatures or fingerprints of objects that may appear in the sensor data. The flagged object database 134 may be initially populated by a system administrator that preemptively flags objects that are inappropriate, forbidden by the rules of gameplay (e.g., a mask that could prevent detection of a participant's emotions), or otherwise worth tracking. In some embodiments, the flagged object database 134 may adapt over time as users and/or system administrators add and remove objects. Additionally or alternatively, the user behavioral safeguard subsystem 190 may implement machine learning to recognize objects that are often present and associated video streams that have been reported as offensive or otherwise failing to comply with rules. That is, if certain objects have a strong correlation with content or behavior perceived to be objectionable, the user behavioral safeguard subsystem 190 may automatically flag those objects to prevent similarly objectionable content or behavior from being seen by users in future game sessions.

One or more user behavioral safeguard subsystems 190 may synchronize their databases 134 with one another. In some embodiments, some or all of the objects in the flagged objects database 134 may be cached at a local database 124 of the device 105. This may enable a more reactive system where a safety protocol may be implemented rapidly after the detection of a flagged object at either a transmitting device 105 that captures the flagged object through its sensors or at a receiving device 105 receiving video and/or audio data having the flagged object. In some embodiments, the user behavioral safeguard subsystem 190 may be fully integrated into a decision engine 110 or a device 105. In some embodiments, a safety protocol may also be triggered when a user reports another user for a particular violation. The video stream and information contained in the manually-submitted report be used to further improve automated implementation of the safety protocol.

The decision engine 110 may be in communication with other decision engines 110 and/or other devices 105 such that a large sample set representative of a plurality of users may be considered for machine learning processes. Alternatively, a centralized database coordination processor (not shown) may send flagged objects to a plurality of user behavioral safeguard subsystems 190 on a periodic or discretionary basis and thereby synchronize the flagged object databases 134 of multiple user behavioral safeguard subsystems 190.

As discussed above, the camera 116 may provide video data that may be interpreted to detect emotions and/or flagged objects. The video data may be further analyzed to provide other types of contextual clues. For example, an image frame in the video data may be used to determine the number of people participating in a call from one device (e.g., the device 105). In some embodiments, a reaction game may only allow one person to be detected at each device, and thus the detection of multiple people may cause a party to receive a warning or automatically forfeit a game session.

Clocks and timers may also provide valuable data for analysis by the decision engine 110. For example, if neither participant exhibits an emotion associated with a loss criterion that would conclude the session after a maximum time period allowable for a game session, the decision engine 110 may end the game session in a draw.

In some embodiments, an account management server 182 may store details and maintain accounts for each participant or player of the mediated response game. The account management server 182 may be in communication with the communications server 180 that facilitates game sessions between or among the players' devices 105. A player's account may be credited when the player's opponents are determined to have displayed emotional response or facial expression (e.g., smile) or otherwise satisfied a loss criterion. The number of points (e.g., in-game tokens) awarded may depend at least in part upon the duration of the game elapsed, and/or the degree of the facial expression and emotional response. For example, players may receive more points for shorter games and may thus be rewarded for provoking emotional responses or reactions more quickly. In some embodiments, players can spend their points to use in-game features such as humorous distractions (e.g., visual overlays or audio clips) to be presented on the devices 105 of their opponents.

In some embodiments, the decision engine 110 may generate confidence ratings when determining different contextual clues from the sensor data. As discussed above, the external services (e.g., the emotion detection engine 160) may also provide confidence ratings about the contextual clues that they provide. The decision engine 110 may determine that a game is over if the confidence rating and/or perceived extent with which a participant or player displays an emotional response is above a threshold established by a loss criterion.

In embodiments where the decision engine 110 is fully integrated into the device 105, the processor 130 may be the same as the processor 112, such that a single processor receives sensor data, determines when a loss criterion is met, and alerts a user of the device 105 about the results. Further, the memory device 132 may be the same as the memory device 122 and may provide instructions that enable the processor to perform the functions disclosed herein.

In some embodiments, the user behavioral safeguard subsystem 190 may be integrated into the communications server, such that it may block potentially offensive content in transit and before it reaches a receiving device 105 intended to receive the potentially offensive content. In some embodiments, the user behavioral safeguard subsystem 190 may be integrated into a device 105. In these embodiments, a single processor 112 and/or a single memory 122 may be used for both the device 105 and the user behavioral safeguard subsystem 170. Further, the flagged object database 134 may be the same as the flagged object database 124 and may store flagged objects detected from the sensors on the device 105 or on signals (e.g., video and/or audio streams) from the communications server 180. The decision engine 110 may thus be bypassed with respect to implementing the safety protocol but may still be used for emotion detection and determining when loss criteria are satisfied.

FIG. 1B shows a schematic diagram illustrating communications between multiple devices 105 that may participate in a reaction game. A communications server 180 may enable a group of devices 105-1 through 105-N to participate in mediated reaction games or otherwise communicate with one another as desired by the users of the devices 105. The communications server 180 may be implemented as a cloud-based server 180 that may service a regional or even global client base through the internet. For example, the communications server 180 may provide videoconferencing-based games between the devices 105, where the devices 105 may be similar or dissimilar to one another. For example, some devices 105 may be desktop computers or stationary gaming consoles and may engage in game sessions with other devices 105 that are tablets, laptop computers, mobile gaming consoles, or mobile phones.

The account management server 182 may store information for the user accounts associated with each device 105 or the users of the devices 105. The stored information may include a list of past games, friends, in-game currency (e.g., tokens), a history of each user's infractions (e.g., as stored whenever the safety protocol is initiated), and other information.

In some embodiments, a game session may have more than two users with devices 105 simultaneously participating. In such embodiments, one or more decision engines associated with the devices 105 may determine when a user of a device 105 displays an emotional response or reaction that satisfies a loss criterion. In some embodiments, whenever a participant or player displays such a response, they may lose the game session, but the game session may continue until a single participant remains (e.g., by not having triggered a loss criterion) or a game timer expires. Participants who have already lost within a game session may choose to spectate until the game session is completed or they may be prompted to disconnect and join another game session.

In some embodiments, the devices 105 may connect to one another in a decentralized and peer-to-peer manner such that the communications server 180 is not used.

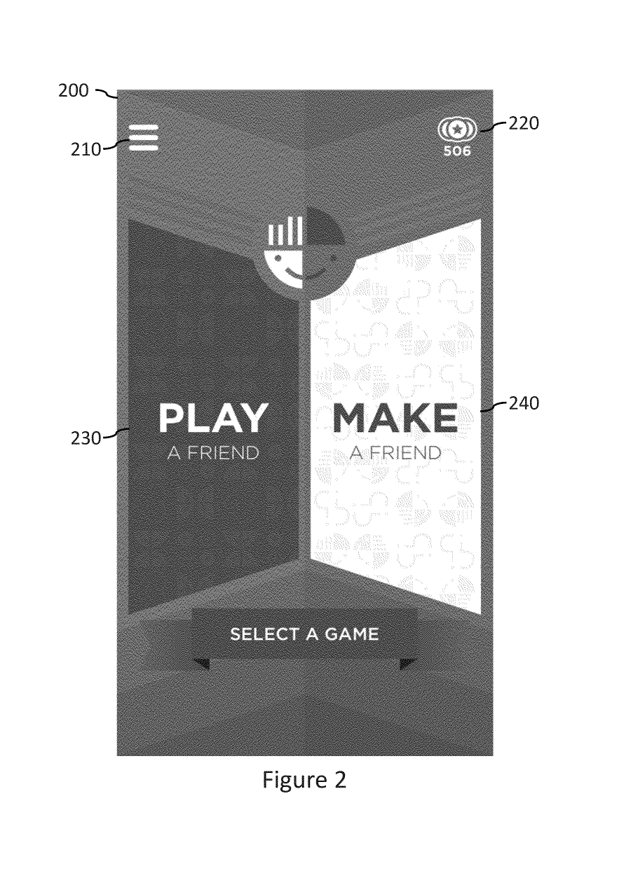

FIG. 2 shows a schematic diagram illustrating a presentation 200 of an introductory game screen associated with a mediated reaction game on a personal electronic device. The presentation 200 may have a feature button 210, which can be used to navigate to other feature screens; a tokens button 220 to check the player's current token balance or purchase additional tokens using a real-world currency; a first play button 230 to initiate a game with an existing friend; and a second play button 240 to play a game against an opponent matched to the player. If the second play button 240 is selected, the matched opponent may not have a pre-existing relationship with the player and may thus be a stranger. Given the uncertainty associated with stranger interactions, the disclosed user behavioral safeguards can lead to a more consistently pleasant gameplay experience.

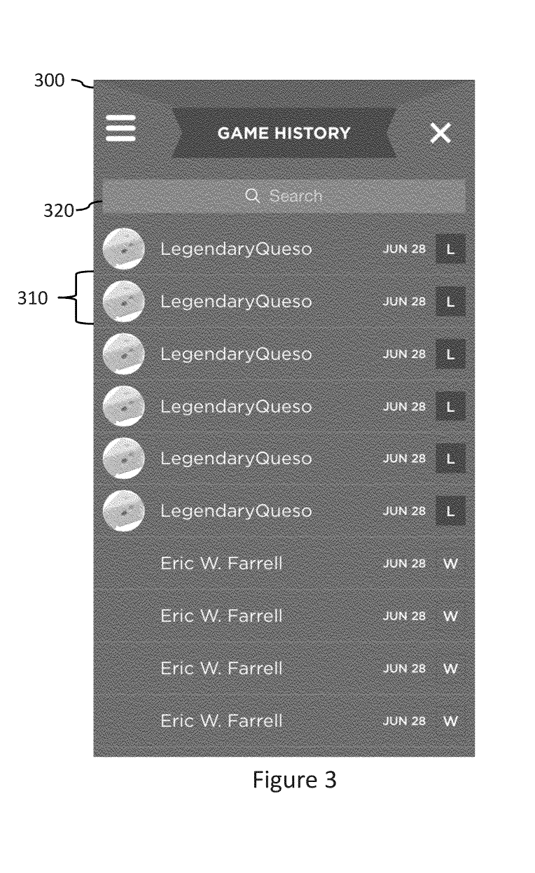

FIG. 3 shows a schematic diagram illustrating a presentation 300 of game history associated with a mediated reaction game on a personal electronic device. The presentation may include a roster of entries 310 representative of game sessions in which a player previously participated. Each entry may have the name of an opponent, an icon selected to be representative of the opponent, a date that the game session occurred, and the outcome of the game session. The presentation 300 may also include a search bar 320, where a user may search through their own game history by opponent name, date, or other search criteria. The game history data may be stored at an account management server as described above.

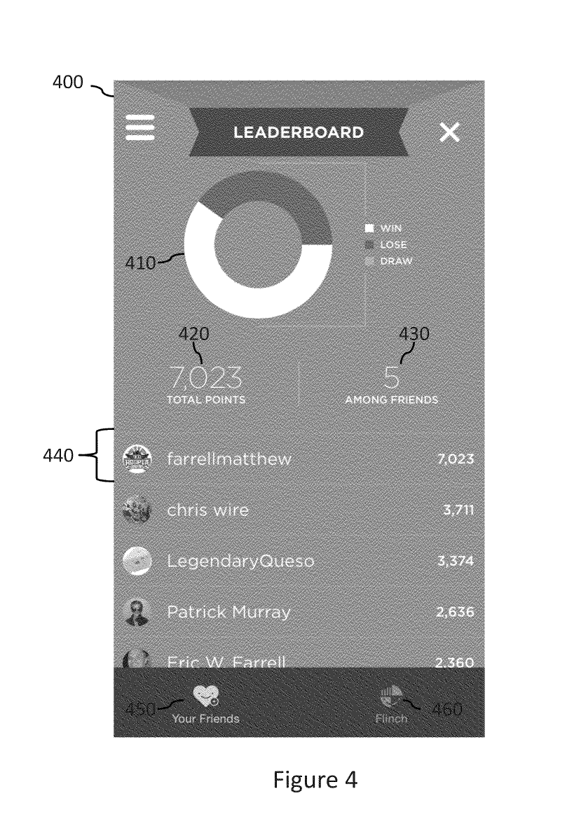

FIG. 4 shows a schematic diagram illustrating a presentation 400 of a leaderboard associated with a mediated reaction game on a personal electronic device. The presentation 400 may include a graph or other display image 410 showing a particular player's performance through their wins, losses, and ties. The presentation 400 may also include a cumulative score indicator 420, a relative ranking 430 among the player's friends, and leaderboard entries 440 of the scoring leaders and their corresponding scores. The presentation 400 may also include a first button 450 to limit the leaderboard entries 440 to be selected from only friends of the player and a second button 460 to see a complete leaderboard, with entries 440 selected from all players of the reaction game.

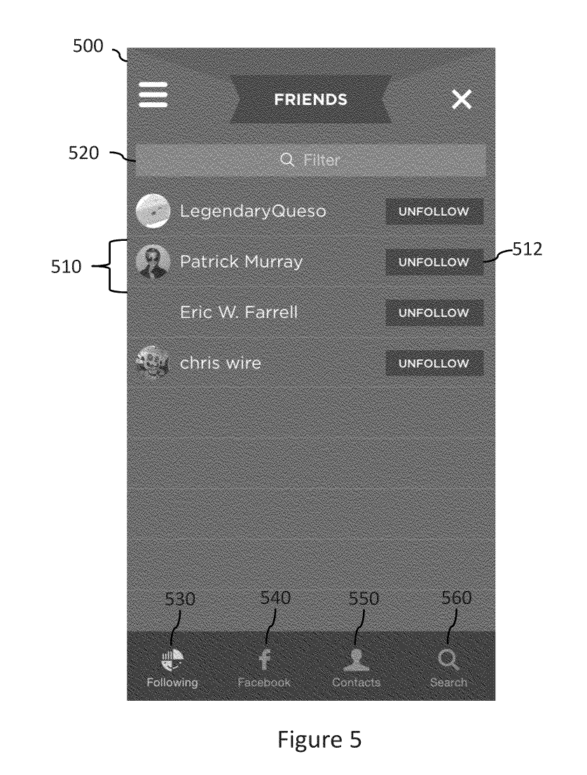

FIG. 5 shows a schematic diagram illustrating a presentation 500 of a friends list associated with a mediated reaction game on a personal electronic device. A player may add friends to their friends list by electing to “follow” them. Each followed friend may have an entry 510 shown in the presentation 500, where the entry 510 may include the friend's name and icon as well as a button 512 to “unfollow” or remove the friend. In some embodiments, past opponents may be automatically added to the player's friends list. The player may use a filter bar 520 to filter their friends list to more easily find particular individuals (e.g., using their account name as stored by an account management server). If a player has not yet chosen to follow any friends within the game, the presentation 500 can have an instructional message for adding friends that serves as a placeholder.

The presentation 500 may have a “following” button 530 to list friends that a player is presently following, as is depicted to be selected in FIG. 5 to show the entries 510. The presentation 500 may also have one or more social network(s) button 540 linking to the player's social network, a contacts button 550 linking to the contacts within the player's personal electronic device (e.g., a mobile phone contact list), and a search button 560 to search for users within the reaction game community that the player has not yet followed.

In general, the buttons 540, 550, and 560 may allow a player to follow and/or challenge others within or outside of the player's networks. The challenged players who do not already have the game installed may receive a message (e.g., via email or text message) having a link and instructions for downloading the game.

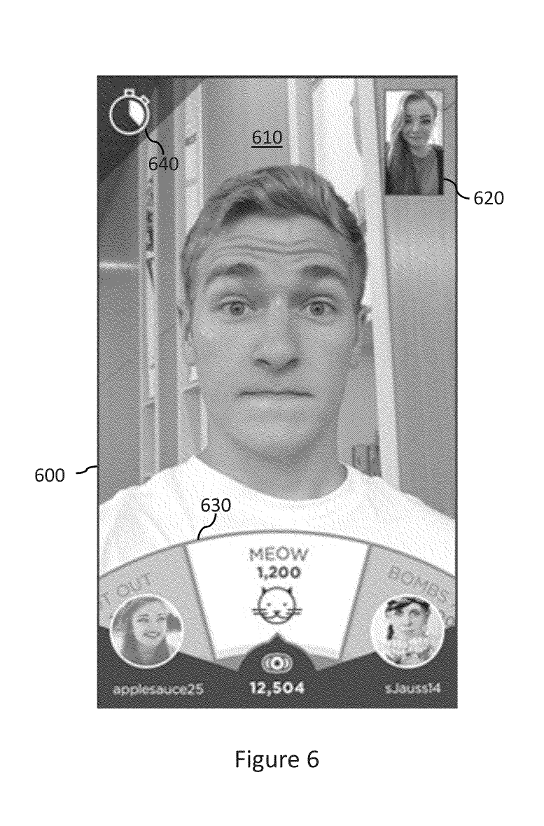

FIG. 6 shows a schematic diagram illustrating a presentation 600 on a personal electronic device during a session of a mediated reaction game. A user may challenge another user through an application installed on at least one of the users' devices. When the game session is established, participants may see and hear one another through the interfaces of their respective devices. A video stream of an opponent may be presented to the other participant in a primary window 610, and a video stream of a participant may be presented to themselves in a secondary window 620. In some embodiments, the primary window 610 showing the opponent may be more prominently displayed (e.g., centered and/or larger) than the secondary window 620 showing the participant themselves. While FIG. 6 shows the presentation 600 that is provided to one participant, a similar presentation may be presented to another participant (or participants in a group conversation). For example, each participant may see their opponent(s) in primary window(s) (e.g., the window 610) and may see themselves in a smaller window (e.g., the window 620). More windows may be presented if more users and devices are participating in the conversation. A timer 640 may indicate the progression of an ongoing game session. If the timer 640 expires, the game session may be declared a draw between the remaining players.

A decision engine associated with one or more of the game participants' devices may monitor the video signals that are presented in the windows 610 and 620 as well as other sensors associated with the participants' devices. The decision engine may determine if and when a participant exhibits an emotional response (e.g., smiling) to trigger a loss criterion. As described above with respect to FIG. 1A, the decision engine's determination of winners and losers may be assisted by an emotion detection engine that also receives the video signals and provides real-time indications of detected emotions to the decision engine. When a participant provides such a response, all participants within a game session may be alerted that the participant who displayed the response has lost the game. If the game has more than two participants, it may continue until a single participant remains (e.g., by not exhibiting an emotional response).

During a game session, participants may attempt to incite one another into exhibiting an emotional response by using features built into the game. For example, participants may select visual overlays (e.g., digital stickers or animations), audio clips, or other features from a selectable feature window 630 that may be presented to their opponents. Other types of features include digital apparel and avatars that track movement of a participant. In some embodiments, these features may be purchased using in-game currency (e.g., tokens), which may be earned by winning or simply participating in games. In some embodiments, in-game currency may be additionally or alternatively purchased using real-world currency.

If a participant wants to use another feature that is not immediately presented in the selectable feature window 630, the participant may make a gesture to receive the additional content. For example, the participant may use a tactile feedback element such as a touch screen or mouse to drag the window 630 sideways, which may prompt additional features to “rotate” into or otherwise appear in the selectable feature window 630. If a participant does not want to use any features, they may perform yet another gesture (e.g., dragging the window 630 downward or selecting a “hide features” button) to make the selectable feature window 630 disappear.

After a feature such as a sticker is selected by one user and presented to another user, the other user receiving the feature may be presented with a set of selectable features that may be relevant as a direct or indirect response to the received feature. Accordingly, the features presented in the selectable feature window 630 may help drive interaction between users.

The set of selectable features in the selectable feature window 630 may be chosen for presentation to a participant based on a context perceived through video data analysis. For example, if a participant initiates a session from a particular location, the selectable feature window 630 of the participant and/or an opponent may provide features relating to the participant's location. In some embodiments, the features suggested in the selectable feature window 630 may be random. In some embodiments, the users may also attempt to win by speaking (e.g., telling a joke) to have their opponents display an emotional response.

As described above, one or more user behavioral safeguard subsystems may also be active when a game is in progress. If a participant does not follow the rules of the game (e.g., showing one's face) or displays a flagged object that is recognized from their video stream, a user behavioral safeguard subsystem may initiate a safety protocol. The safety protocol may comprise disabling an offending video stream, censoring portions of the offending video stream, disconnecting the participants from one another, and/or other actions to promote safe and proper usage of a reaction game system.

Further, the disclosed principles may apply to many different types of communications beyond videoconferencing. In some embodiments, the disclosed principals may be applied audio conferencing sessions. In embodiments involving audio data, factors such as pitch, cadence, and other aspects of speech or background noise may be analyzed to discern emotions and other contextual information. Some sensors, such as location sensors, may still be relevant and applicable across the different communications media.

The types of features presented to a user may also vary based on the selected communications media. For example, if multiple users are competing with one another in an audio conferencing-based game, the users may be presented with sound clips or acoustic filters that may applied to the conversation. The features may, for example, be selectable from a dedicated auxiliary window or from a keypad. Further, certain words may be flagged by a user behavioral safeguard subsystem to be filtered out of the conversation. A minor delay may be introduced to enable recognition and filtering of flagged words.

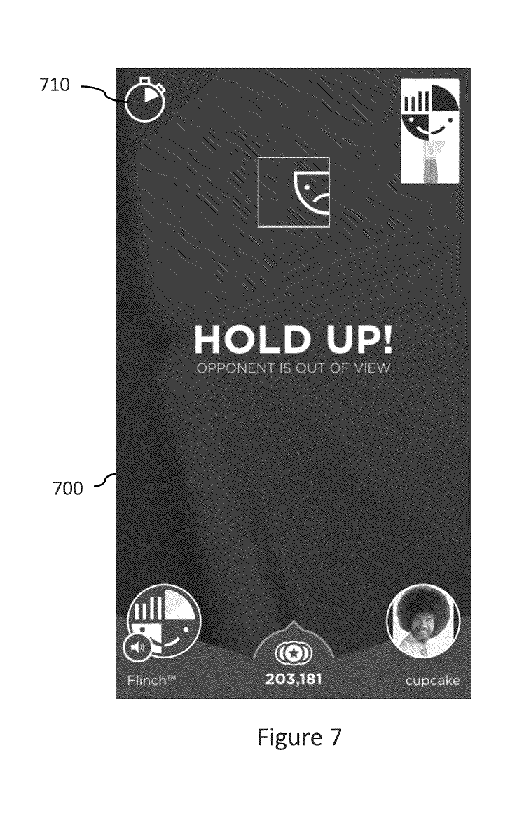

FIG. 7 shows a schematic diagram illustrating a presentation 700 that may occur on a personal electronic device after a safety protocol has been implemented. A participant may see the presentation 700 if they are within an instance of the reaction game and an opponent's face is removed from or not within the captured video stream. In some embodiments, a timer 710 may accelerate and provide a limited time before the game session is ended. The user associated with the blocked feed may automatically forfeit the game and lose points. Frequent violations or failures to play the game may result in a temporary or permanent ban from playing the game.

In some embodiments, if a user behavioral safeguard subsystem detects a flagged object in the video stream of a participant, other participants within the game may see the presentation 700, which blocks the video stream having potentially offensive, undesirable, or otherwise restricted content from reaching the participants. Other safety protocols such as partially obscuring a video feed, muting an audio feed, and disconnecting a game session may also be implemented to respond to different types and severities of offenses.

While FIG. 7 shows the results of blocking video content in the context of a reaction game, similar techniques for automatically disabling or obscuring video feeds based on recognizing flagged objects may adapted for numerous other applications. For example, a frequent user of a streaming video service may create a list of preferences about objects they would not like to see within incoming streams. The service may use a flagged object database and video recognition technology to obscure portions of incoming video streams having those objects. In some embodiments, the objects may be selectively blurred or a video stream may be disabled altogether. Such features may be immensely useful to individuals having phobias towards particular animals or other objects. Similarly, certain brand logos and written text may also be selectively blocked within video streams (e.g., to avoid copyright or trademark infringement).

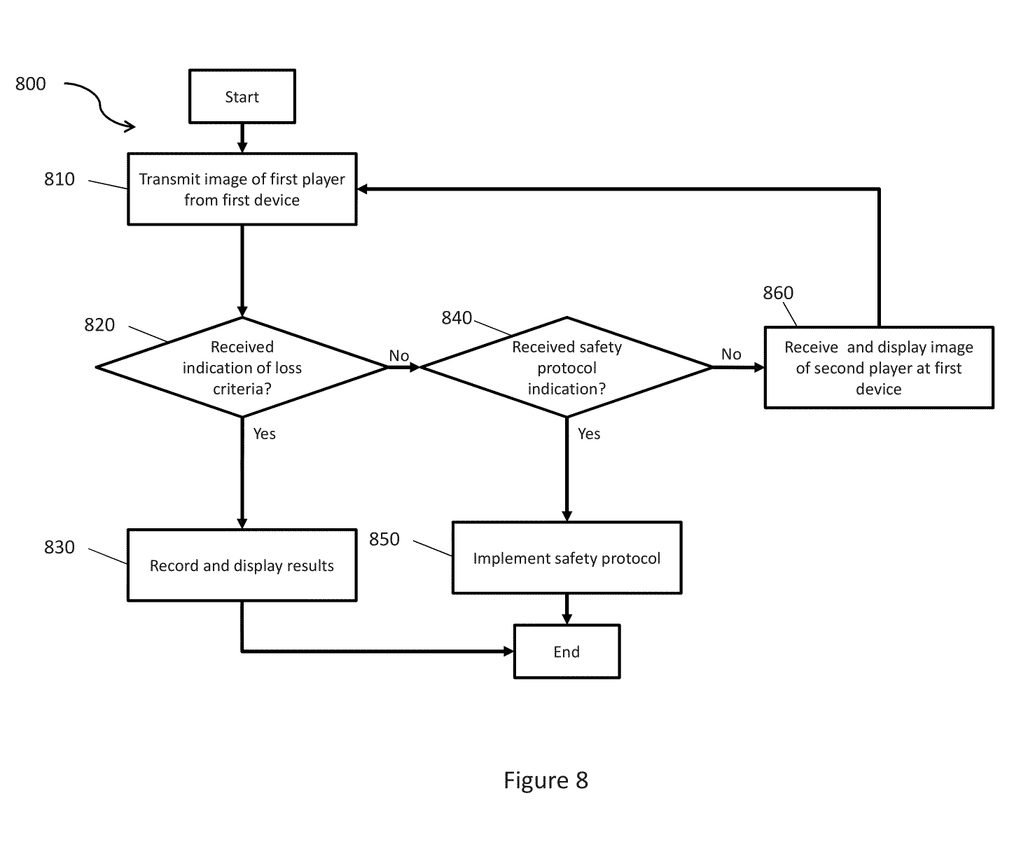

FIG. 8 shows a flowchart illustrating an exemplary process 800 for participating in a mediated reaction game. The process 800 may be performed by a first device of a first participant playing the game. While the process 800 is described below as having a plurality of participants and devices, the mediated reaction game may also have a single participant within a session. With regard to embodiments where a plurality of participants play against one another, the first participant may directly challenge one or more other participant to begin the game, or the participants may be matched with one another prior to the process 800. If the players are matched, the matching process may be performed by a communications server and may take age, gender, location, game history (e.g., win/loss ratio, number of games played), and/or other factors into account.

At an action 810, the first device may transmit an image frame or portion of a video stream to a communications server that is facilitating a game session between the first device and at least a second device of a second player within the game. This may be an initial video stream portion or a subsequent video stream portion depending on whether or not the game recently began. The image frame or video stream portion may also be transmitted to and analyzed by a decision engine and/or supplementary engines and subsystems, which may each be internal or external to the first device, to determine if a loss criteria has been satisfied (e.g., a smile, eye-movement, other facial change, or detectable emotion) and whether a safety protocol should be implemented. For example, a user behavioral safeguard subsystem may analyze the video streams or individual image frames from the first and second devices to determine whether or not they contain flagged objects or are missing objects required for the game (e.g., the first participant's face). In some embodiments, the first device may also transmit audio data and/or other information.

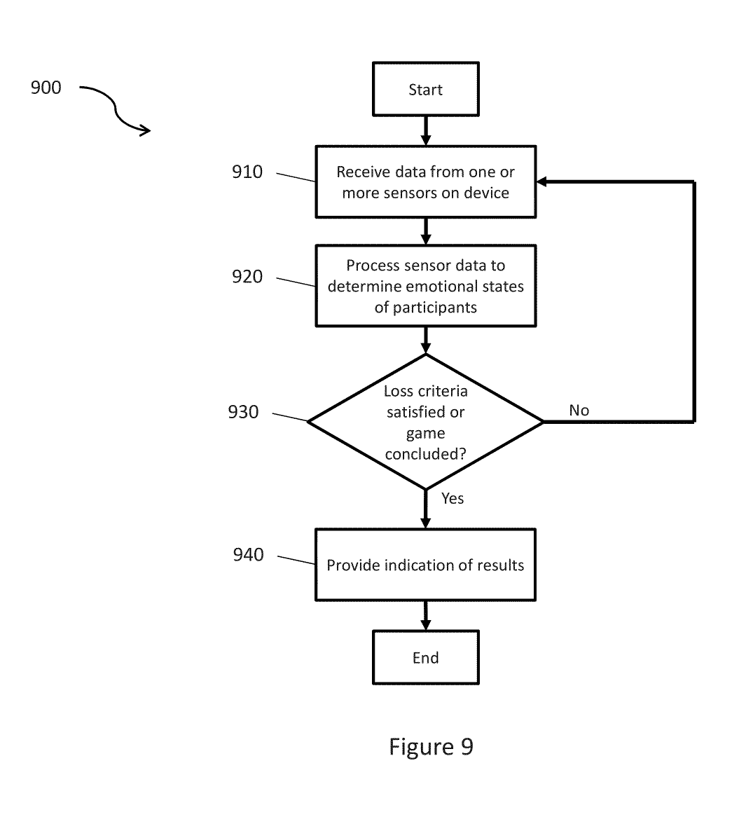

At an action 820, the first device may check whether or not it received an indication that a loss criterion has been satisfied (e.g., from a decision engine). Video streams or image frames from both (or all) participating devices may be analyzed (e.g., by an emotion detection engine) to determine whether a player has smiled, moved, or shown emotion beyond a threshold level. In some embodiments, the threshold level may be optimized over many iterations of the game to balance responsiveness and difficulty with playability. In some embodiments, players may select a difficulty level before or after being matched with an opponent, and the threshold level for a particular game session may be adjusted based on the selected difficulty level. FIG. 9 and the accompanying description below provide more detail into conducting the game itself and determining when the loss criteria is satisfied. If the first device receives an indication of a loss criterion, the process 800 may proceed to an action 830. Otherwise, the process 800 may proceed to an action 840. In some embodiments, the process 800 may also proceed to the action 830 if a game timer expires and the game ends in a draw.

At the action 830, the first device may record and display the results of the game. In some embodiments having tokens, the winner may win a larger number of tokens from playing the game than the loser(s). Furthermore, the number of tokens awarded may decrease as a function of the time required for a loss criterion to occur. This rewards players who are able to effectively provoke an emotional response or reaction in other players (e.g., through adept usage of available stickers and other features). In some embodiments, the loser(s) of the game may not win any tokens or may lose tokens after losing the game. If the game ends in a draw, both or all tied players may receive an equal amount of tokens. An account management server in communication with the communications server may record the game and its results to both or all players' game histories.

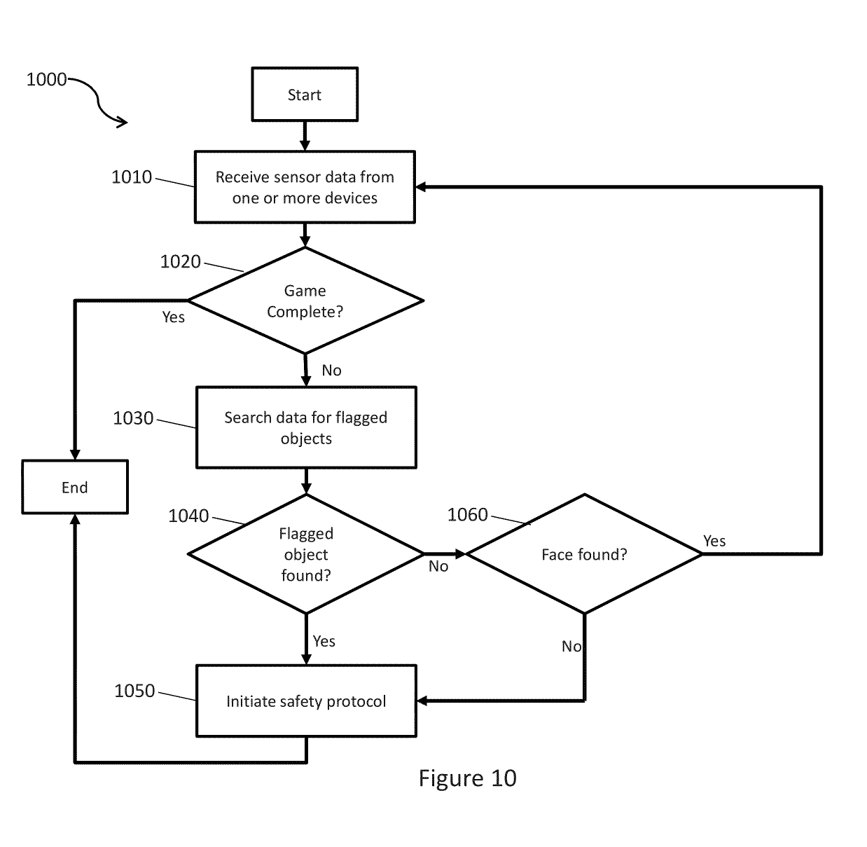

At the action 840, the first device may check whether or not it has received an indication about a safety protocol from the user behavioral safeguard subsystem. FIG. 10 and the accompanying description below provide more detail about safety protocols and, more generally, improving the overall safety of the game. If the first device and/or the user behavioral safeguard subsystem determine that the safety protocol is to be implemented, the process 800 may continue to an action 850. If not, the process 800 may continue to an action 860.

At the action 850, the first device may implement the safety protocol. This may entail blanking the video stream or image frames received from the second device and instead displaying a placeholder message, such the one as shown in FIG. 7. The safety protocol may vary depending on the nature of the triggering action. In some scenarios where the triggering action is minor, the safety protocol may entail merely blurring a portion of the video stream or muting the audio, and the process 800 may continue (e.g., to the action 860). In scenarios where the safety protocol allows the process 800 (and associated game session) to continue, a timer may be initiated such that the game session may be concluded early if the triggering action that instituted the safety protocol is not remedied in a sufficiently prompt manner (e.g., 5, 10, or 15 seconds). Conversely, in scenarios where the triggering action is major and/or a repeat violation, the safety protocol may entail substantially immediately disconnecting the users from one another and ending the game session. In some embodiments, the offending video stream may alternatively be caught and/or altered at a communications server or even the sending device, such that the potentially offensive content is prevented from reaching the first device.

At the action 860, the first device may receive and display an image frame or portion of a video stream of the second player to the first player. This may be an initial video stream portion or a subsequent video stream portion depending on whether or not the game recently began. If the first device is used to analyze this data for loss conditions and/or safety-related decisions, there may be a delay between receiving and displaying the data. The process may then proceed to the action 810, where the next portion of the video stream or image frame from the first device is transmitted and/or analyzed. In some embodiments, the first device may also receive audio data and/or other information.

The actions described in the process 800 may be performed by the first device in accordance with instructions stored on a nonvolatile, machine-readable medium. Furthermore, the actions described in the process 800 may not necessarily take place in the presented order. For example, the first device may have a multi-threaded processor or multiple simultaneously running subsystems that continuously check for indications of the safety protocol and the loss criteria in a simultaneous manner and in parallel to receipt, presentation, and transmission of video streams. In some embodiments, more, fewer, or different actions may be implemented by devices participating in a reaction game. For example, in embodiments having a single participant playing the game (e.g., using a timer and/or against an artificial, computer-generated opponent), the actions 840 and 850 relating to the safety protocol may be bypassed.

FIG. 9 shows a flowchart illustrating an exemplary process 900 for conducting a mediated reaction game. The process 900 may be performed by a decision engine that may be external to or integrated with a user's personal electronic device.

At an action 910, the decision engine may receive sensor data from the devices of the player(s) involved in a game session. As described above with respect to FIG. 1A, this sensor data may be provided from a multitude of sensors associated with one or more devices within a game session, such as microphones, cameras, location sensors, and tactile input elements. In some embodiments, each device may have a dedicated decision engine that receives and processes the sensor inputs from that device. In some embodiments, the decision engine may be located at a backend server and/or integrated into the communications server supporting video transmission for the game session, and the decision engine may process sensor inputs (e.g., transmitted video streams) from all devices involved in the game session.

At an action 920, the decision engine may process the sensor data to determine emotions of the player(s) within the game. In some embodiments, this processing may comprise the decision engine providing the sensor data to an emotion detection engine through an external interface. The emotion detection engine may return information about detected facial expressions and emotions, which may include confidence ratings and/or perceived intensity.

At an action 930, the decision engine may determine whether a loss criteria is satisfied or if the game has concluded for other reasons (e.g., timer expiry). In some embodiments, the decision engine may compare the confidence ratings and/or perceived intensities of detected facial expressions against a list of prohibited facial expressions (e.g., a smile) and corresponding threshold values to determine when a player loses. In some embodiments, the loss criteria may comprise a player flinching (e.g., rapidly moving their face or body) beyond a threshold level, where the threshold level may be established prior to the game and/or by a selected difficulty level. Other perceived indications of emotion or the players' mental states may be used as loss criteria to determine when a game should conclude. If the decision engine determines that a loss criterion has been satisfied or the game has otherwise concluded, the process 900 may proceed to an action 940. Otherwise, the process 900 may return to the action 910, where the decision engine may receive new sensor data (e.g., for the next instant or period of time).

At the action 940, the decision engine may provide a notification to the one or more devices involved in the game that the game has concluded and also which player(s) won, lost, or tied with one another. When the decision engine is provided by a backend server located remotely from the devices, the game results may be transmitted over the internet. If the decision engine is integrated into a device, the action 940 may simply involve presentation of the results on that device and/or transmission of the results to the device(s) of the other participant(s).

As discussed above, a session of a mediated reaction game may involve a single player. In some embodiments, various features may be automatically provided at the player's device during a single-player game session to elicit a response from the player. The player may achieve victory if they do not exhibit a response within and throughout a period of time established by a game timer. In some embodiments, the player may be matched with a computer opponent that is displayed on the player's device and programed to react to actions taken by the player, so as to simulate gameplay with another human being.

The actions described in the process 900 may be performed by the decision engine in accordance with instructions stored on a nonvolatile, machine-readable medium. Furthermore, the actions described in the process 900 may not necessarily take place in the presented order. In some embodiments, more, fewer, or different actions may be implemented by devices participating in a reaction game.

FIG. 10 shows a flowchart illustrating an exemplary process 1000 for providing user safety in a mediated reaction game. While the process 1000 is generally described below as being performed by a single user behavioral safeguard subsystem, multiple of such subsystems may be implemented to improve the safety of a game session. For example, each device participating in a game session may have an associated user behavioral safeguard subsystem that acts as a safeguard for that device (e.g., preventing display of received data that is potentially offensive) or for other devices (e.g., preventing transmission of potentially offensive data). The user behavioral safeguard subsystem(s) may be integrated into or in communication with the participants' devices. The user behavioral safeguard subsystem may, in some embodiments, be integrated into a communications server supporting video transmission for the game session.

At an action 1010, the user behavioral safeguard subsystem may receive data from sensors on one or more devices participating in a game session. This data may include an image frame or portion of a video stream. In some embodiments, the user behavioral safeguard subsystem may also receive audio data and/or other information from or about the devices.

At an action 1020, the user behavioral safeguard subsystem may check whether it has received indication that a game is completed (e.g., from a decision engine associated with the game). If the game is determined to have been completed, the process 1000 may end. Otherwise, the process may continue to an action 1030.

At the action 1030, the user behavioral safeguard subsystem may search the sensor data for objects stored in a flagged object database. The objects may be flagged by the community of the mediated reaction game or automatically (e.g., based on commonalities of image frames or video streams flagged by users as being inappropriate or otherwise not following rules associated with the game). In some embodiments, this search may occur substantially in real time with respect to an input stream.

At an action 1040, the user behavioral safeguard subsystem may determine whether or not any flagged objects are present in the sensor data. If such objects are found, the process 1000 may continue to an action 1050, where the safety protocol in initiated. If not, the process 1000 may continue to an action 1060.

At the action 1050, the user behavioral safeguard subsystem may initiate a safety protocol. The safety protocol may dictate any of a varied set of procedures based on the degree and type of infraction. For example, in some scenarios, the safety protocol may dictate censoring (e.g., blurring or overlaying with censoring graphics) only portions of image frames within a stream. This may be useful when the flagged object is incidentally in the background of one or more image frames and a receiving party indicates that they do not wish to see such content (e.g., a person who has a phobia of a typically-mundane object or who strongly dislikes a certain brand). In these scenarios, the process 1000 may return to the action 1010 (e.g., such that the user behavioral safeguard subsystem continues to monitor sensor data for the game session). In other scenarios, the safety protocol may entail automatically ending the game session and disconnecting the participants from one another. An account management server may track and store incidents where a player's video stream or actions prompted the safety protocol so as to allow for more strict and/or permanent actions for those with frequent and/or serious infractions.

At the action 1060, the user behavioral safeguard subsystem may verify whether or not a face (or another object potentially required for the game) is detected within the sensor data. If a face is not detected, the process 1000 may continue to the action 1050 where the safety protocol is initiated. If a face is detected, the process 1000 may continue to the action 1050 and the safety protocol may be initiated. Otherwise, the process 1000 may return to the action 1010, where the user behavioral safeguard subsystem receives a new set of sensor data for analysis.

The actions described in the process 1000 may be performed by the user behavioral safeguard subsystem in accordance with instructions stored on a nonvolatile, machine-readable medium. Furthermore, the actions described in the process 1000 may not necessarily take place in the presented order. In some embodiments, more, fewer, or different actions may be implemented by devices participating in a reaction game.

Other features for improving the safety and/or general enjoyability of a reaction game include allowing players to block other players with which they do not wish to interact. A blocked player may be prevented from challenging or randomly being matched with another player requesting the block. Furthermore, individuals who are repeatedly found and/or reported to abuse the mediated reaction game platform (e.g., by not following terms and conditions for which acceptance may be required prior to gameplay) may have their accounts suspended or terminated. By storing and blacklisting device-identifying information such as a phone number or serial number, such users may be prevented from creating a new account and further misusing the service.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It is contemplated that the decision engines, emotion detection engines, user behavioral safeguard subsystems, communications servers, account management servers, personal electronic devices, and other elements be provided according to the structures disclosed herein in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Memory devices may store any suitable information. Memory devices may comprise any collection and arrangement of volatile and/or non-volatile components suitable for storing data. For example, memory devices may comprise random access memory (RAM) devices, read only memory (ROM) devices, magnetic storage devices, optical storage devices, and/or any other suitable data storage devices. In particular embodiments, memory devices may represent, in part, computer-readable storage media on which computer instructions and/or logic are encoded. Memory devices may represent any number of memory components within, local to, and/or accessible by a processor.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Networked computing environment such as those provided by a communications server may include, but are not limited to, computing grid systems, distributed computing environments, cloud computing environment, etc. Such networked computing environments include hardware and software infrastructures configured to form a virtual organization comprised of multiple resources which may be in geographically disperse locations.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “immediately,” “equivalent,” “during,” “complete,” “identical,” and the like should be understood to mean “substantially at the time,” “substantially immediately,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Field of the Disclosure,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of providing safety for a digital media-based reaction game, the method comprising:
storing flagged objects within a flagged object database, wherein the flagged objects are chosen for being inappropriate or otherwise worth tracking for the digital media-based reaction game;
receiving an image frame captured by a device in a game session of the digital media-based reaction game;
analyzing the image frame to determine whether the image frame contains one or more of the flagged objects within the flagged object database; and
initiating a safety protocol if the image frame is determined contain at least one of the flagged object within the flagged object database.

2. The method of claim 1, wherein the safety protocol comprises disconnecting the device from at least one other device participating in the game session, thereby ending the game session.

3. The method of claim 1, wherein the safety protocol comprises allowing the game session to continue but not allowing the image frame to be presented at another device participating in the game session.

4. The method of claim 1, wherein the safety protocol comprises allowing a first portion of the image frame to be presented at another device participating in the game session but censoring a second portion of the image frame having the at least one flagged object within the flagged object database.

5. The method of claim 1, wherein the flagged objects are added to the flagged object database after being flagged by participants of the digital media-based reaction game.

6. The method of claim 1, wherein the flagged objects are added to the flagged object database after analyzing commonalities of image frames flagged by participants as being inappropriate or otherwise not following rules associated with the videoconferencing-based reaction game.

7. The method of claim 1, further comprising:
analyzing the image frame to determine whether the image frame contains an object required for the digital media-based reaction game; and
initiating the safety protocol if the image frame does not contain the object required for the digital media-based reaction game.

8. The method of claim 7, wherein the object required for the digital media-based reaction game is a face.

9. A method of participating in a digital media-based reaction game, the method comprising:
capturing, by a sensor of a first device of a first participant, first sensor data associated with the first participant during a game session against a second participant having a second device;
transmitting, by the first device, the first sensor data to the second device or a communications server in communication with the second device,
wherein the first sensor data is received and displayed on the second device;
receiving, by the first device, second sensor data associated with the second participant;
receiving, by the first device, an indication that one of the first participant and the second participant exhibited an emotional response; and
displaying, at the first device, results of the game session after receiving the indication of the emotional response.

10. The method of claim 9, further comprising:
receiving, by the first device, an indication that one of the first participant and the second participant violated rules of the digital media-based reaction game; and
implementing a safety protocol.

11. The method of claim 10, wherein implementing the safety protocol entails disconnecting the first device and the second device from one another and ending the game session.

12. The method of claim 9, further comprising:
determining, using an input element of the first device, if the first participant selects a feature,
wherein the feature is one of a visual overlay and an audio clip; and
transmitting, by the first device, instructions to present the feature on the second device if the feature is selected by the first participant.

13. A system for mediating a digital media-based reaction game having one or more loss criteria, the system comprising:
a communications server operable to connect a first device of a first participant with a second device of a second participant such that the first participant and the second participant can play a session of the digital media-based reaction game against one another;
a user behavioral safeguard subsystem in communication with the communications server, the user behavioral safeguard subsystem operable to initiate a safety protocol in response to detection of a flagged object within a first video stream transmitted by the first device or within a second video stream transmitted by the second device; and
a decision engine in communication with the communications server, the decision engine operable to determine a winner of the game session after determining that at least one of the loss criteria of the digital media-based reaction game has been satisfied.

14. The system of claim 13, wherein at least one of the loss criteria is satisfied when an emotional response is detected within either the first video stream or the second video stream.

15. The system of claim 14, wherein the emotional response is a smile made by one of the first participant and the second participant.

16. The system of claim 13, wherein the user behavioral safeguard subsystem is further operable to initiate the safety protocol when the first participant's face is not detected within the first video stream or the second participant's face is not detected within the second video stream.

17. The system of claim 13, wherein at least one of the user behavioral safeguard subsystem and the decision engine is integrated into the first device.

18. The system of claim 13, further comprising:
an account management server operable to store account information associated with the first participant, wherein the account information comprises at least one of an amount of in-game currency, a record of previous games played by the first participant, and a list of infractions committed by the first participant.

19. The system of claim 13, wherein the communications server is further operable to connect more than two devices of more than two participants to one another, such that the more than two participants can jointly play a session of the digital media-based reaction game.

20. The system of claim 19, wherein the decision engine is further operable to determine the winner of the game session after determining that a single participant of the more than two participants has not satisfied any of the loss criteria of the digital media-based reaction game.

21. A method for mediating a digital media-based reaction game, the method comprising:
receiving or capturing an image frame of a participant in a game session of the digital media-based reaction game;
analyzing the image frame to determine whether the participant exhibits a response associated with one or more loss criteria; and
ending the game session if it is determined that the participant exhibits the response associated with the one or more loss criteria.

22. The method of claim 21, wherein the response associated with the one or more loss criteria is a facial expression, an eye movement, or another body movement made by the participant.

23. The method of claim 21, further comprising:
ending the game session upon expiration of a time limit if it is determined that the participant has not exhibited the response associated with the one or more loss criteria within the time limit.

24. The method of claim 21, further comprising:
providing a feature to the participant so as to provoke the response associated with the one or more loss criteria,
wherein the feature is one of a visual overlay and an audio clip.
